(19) United States
(12) Patent Application Publication
(10) Pub. No.: US 2017/0370492 A1
(43) Pub. Date: Dec. 28, 2017

(54) VALVE FOR CONTROLLING THE WATER FLOW IN A SANITARY LINE

(71) Applicant: OBLAMATIK AG, Chur (CH)

(72) Inventors: ROLAND OBRIST, Scharans (CH); THOMAS KNUPFER, Chur (CH)

(73) Assignee: OBLAMATIK AG, Chur (CH)

(21) Appl. No.: 15/549,411

(22) PCT Filed: Feb. 16, 2015
(86) PCT No.: PCT/EP2015/053238

§ 371 Date: Aug. 8, 2017

(51) Int. Cl. F16K 31/04; F16K 3/34; F16K 3/08

(52) U.S. Cl. CPC F16K 31/042; F16K 3/08; F16K 3/34

(57) ABSTRACT

A valve for controlling the water flow in a sanitary line has a housing with a housing lower part in which a water supply channel portion, a control channel, and a water discharge channel portion are arranged in the flow direction. The control valve has a valve upper part with a head piece, which is arranged in a housing bore coaxially to the bore axis and to which a stator disc with a first ceramic surface is secured, and with a spindle, with which a rotor disc with a second ceramic surface is in engagement. The control valve also has an electric drive which is arranged in the housing upper part and which is in engagement with the spindle. Two seals which rest against the head piece and the spindle seal the control channel of the control valve from a housing upper part.

The invention relates to a valve for controlling the water flow in a sanitary line, which comprises a housing having a housing lower part and a housing upper part. In this case, a water supply channel portion, and, downstream thereof, a control channel and a water drain channel portion are arranged in the housing lower part.

Such control valves are generally known and have been used for some time in the form of solenoid valves in buildings and vehicles of all types.

Monostable or bistable solenoid valves known from the prior art are typically servo-controlled, by arranging a switching valve having an electromagnetically moved valve piston adjacent to the actual control valve. The control valve comprises a flexible rubber membrane having a small passage opening. The control valve opens when the piston of the switching valve moves out of its seat using magnetic force and water reaches a switching bypass from the sanitary line via the small passage opening in the control valve membrane. The switching bypass comprises a water volume on the rear of the control valve membrane and a bypass line, which leads via the seat of the switching valve and discharges into the sanitary line following downstream from the solenoid valve. The piston of the switching valve moves in a water-filled cylinder. The control valve actually opens because the water pressure present in the sanitary line on the front of the control valve membrane is higher than the counter pressure in the volume on the rear thereof, because this counter pressure is reduced due to the draining water via the bypass line, since the cross section of the bypass supplying the water is smaller than the cross section of the bypass draining the water. If the switching valve is closed by pressing the valve piston onto its seat, the flow through the bypass line is thus stopped and the control valve membrane is pressed back onto its seat surfaces with spring assistance, so that the control valve is also closed. The partially simple design thereof, the short reaction time thereof (time for opening or closing the valve measured from the initiation of the respective action), and the low power consumption thereof can be mentioned as advantages of solenoid valves.

The presence of a rubber membrane is to be mentioned as a significant disadvantage of such solenoid valves, because the use of rubber membranes (in particular in hot water lines) is increasingly forbidden. Moreover, solenoid valves tend toward soiling (clogging of the bypass line and/or permanent flow through the valve because of soiling of the control valve seat), because of which a solenoid valve usually has a dirt filter upstream from the control valve. However, the avoidance of dead volumes in control valves is becoming more and more important, because standing water in dead volumes (such as, for example, in the water volume on the rear of the control valve membrane and/or in the water-filled cylinder of the switching valve of solenoid valves) enables the growth of microorganisms. Infected dead volumes contaminate the sanitary line adjoining downstream on the control valve; water contaminated with microorganisms seriously puts the health of the population into question, however. Needle valves, which are also known from the prior art, are not suitable for controlling the water flow in a sanitary line because of the excessively long reaction time thereof and the relatively large lifting force to be applied to open a needle valve.

The object of the present invention is to propose an alternative valve for controlling the water flow in a sanitary line, which eliminates the disadvantages of known control valves from the prior art.

This object is achieved with a control valve according to the features of claim 1, by proposing a valve for controlling the water flow in a sanitary line, which comprises:
a) a housing having a housing lower part and a housing upper part, wherein a water supply channel portion and, downstream thereof, a control channel and a water drain channel portion are arranged in the housing lower part.

The control valve according to the invention is characterized in that it additionally comprises:
b) a valve upper part having a headpiece and a spindle, wherein the headpiece is arranged at least partially in a housing bore coaxially to the bore axis thereof, wherein the spindle is arranged so it is radially rotatable in a headpiece bore coaxial to the housing bore, and wherein the headpiece comprises a wall, which partially encloses the spindle and which is arranged so it engages in the control channel of the control valve;
c) a stator disk, which is arranged in the control channel coaxially to the headpiece bore and is fastened on the headpiece, having at least one through-flow opening, which penetrates this first valve disk, and having a first ceramic surface;
d) a rotor disk, which is arranged coaxially to the headpiece bore in the control channel and is engaged with the spindle, having at least one through-flow opening penetrating this second valve disk and having a second ceramic surface arranged downstream of the stator disk, which lies so it is axially rotatable on the first ceramic surface of the stator disk; and
e) an electrical drive, which is arranged in the housing upper part and is engaged with the spindle of the valve upper part.

The control valve according to the invention is additionally characterized in that a first circumferential seal of the headpiece presses against a surface of this housing bore to form a seal and a second circumferential seal of the spindle presses against an inner surface of the headpiece bore to form a seal, so that these seals seal off the control channel of the control valve in relation to the housing upper part. The control valve according to the invention is additionally characterized in that the headpiece wall comprises at least one window arranged in the region of the control channel, which is oriented, opposite to the water drain channel portion, toward the surface of the housing bore, whereby complete flushing through of the control channel is ensured when the control valve is open.

Further features according to the invention result from the dependent claims. Advantages of the control valve according to the invention comprise:
1) No rubber membrane is used, so that the conditions of all relevant authorities can be met.
2) The valve disks used, which are made of ceramic or at least have ceramic surfaces thereof oriented toward one another and forming seals on one another, are insensitive to soiling.
3) A bypass line does not exist, but rather upon each opening of the control valve, thanks to the special seal in relation to the housing upper part and thanks to the special guidance of the water flow in the control channel through a window oriented to the rear, the entire control channel and therefore all water-conducting parts of the control valve are completely flushed through. Therefore, no dead volumes exist in this control valve.

The control valve according to the invention will be explained on the basis of drawings, which show an exemplary embodiment, and on the basis of diagrams, which illustrate a selection of possible further embodiments. In the figures:

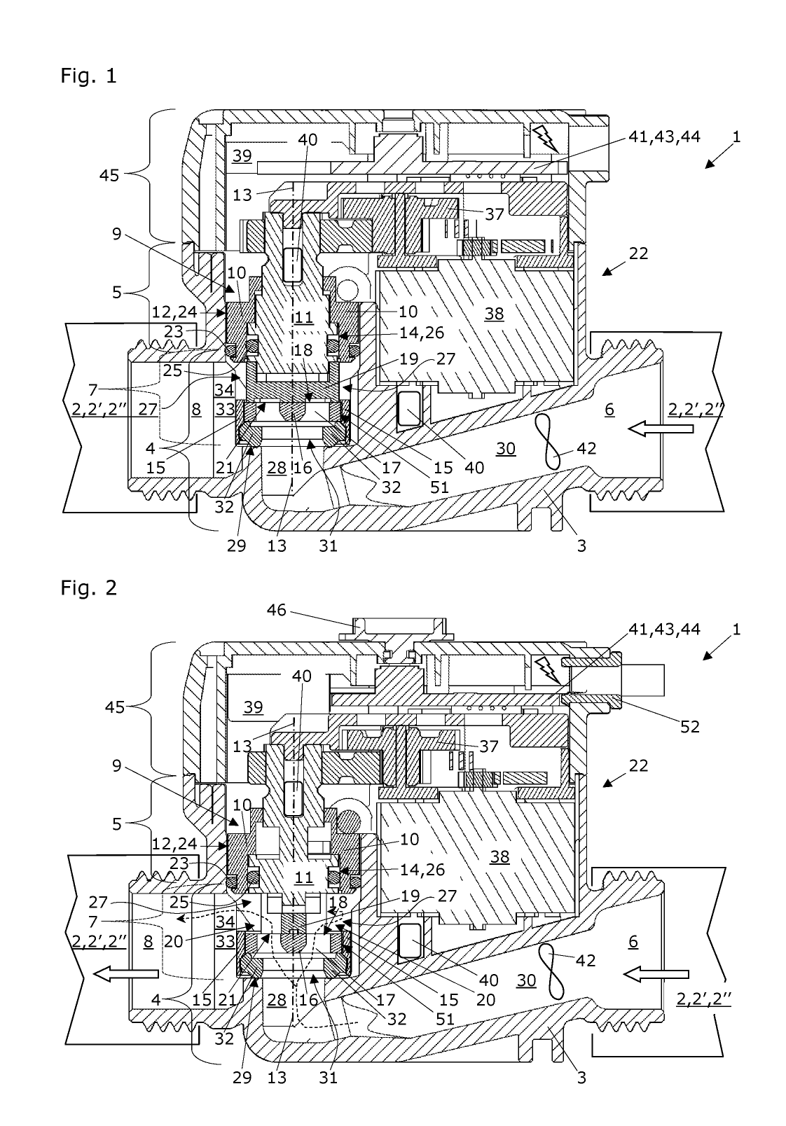

FIG. 1 shows a vertical longitudinal section through a standing control valve according to a first embodiment in a closed state, wherein the water supply channel portion and the water drain channel portion are arranged in a plane common with the bore axis, and wherein the outflow bore and the water drain channel portion are arranged coaxially to one another;

FIG. 2 shows a vertical longitudinal section through the standing control valve of FIG. 1 in an open state;

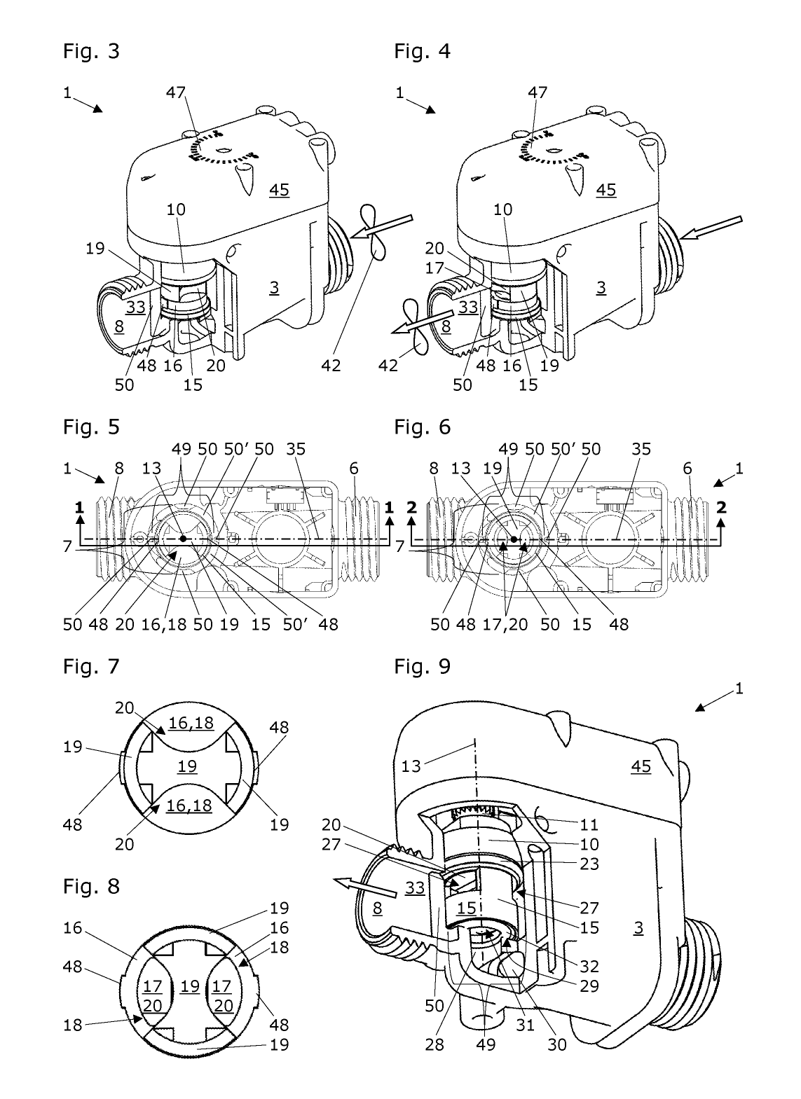

FIG. 3 shows a partially cutaway 3D illustration of the control valve of FIG. 1 in the closed state, viewed from above;

FIG. 4 shows a partially cutaway 3D illustration of the control valve of FIG. 2 in the open state, viewed from above;

FIG. 5 shows a horizontal longitudinal partial section through the control valve of FIGS. 1 and 3 with indicated section guide for FIG. 1;

FIG. 6 shows a horizontal longitudinal partial section through the control valve of FIGS. 2 and 4 with indicated section guide for FIG. 2;

FIG. 7 shows a top view of the two valve disks with closed control valve corresponding to FIGS. 1, 3, and 5;

FIG. 8 shows a top view of the two valve disks with open control valve corresponding to FIGS. 2, 4, and 6;

FIG. 9 shows a partially cutaway 3D illustration of the control valve of FIG. 2 in the open state, viewed from below;

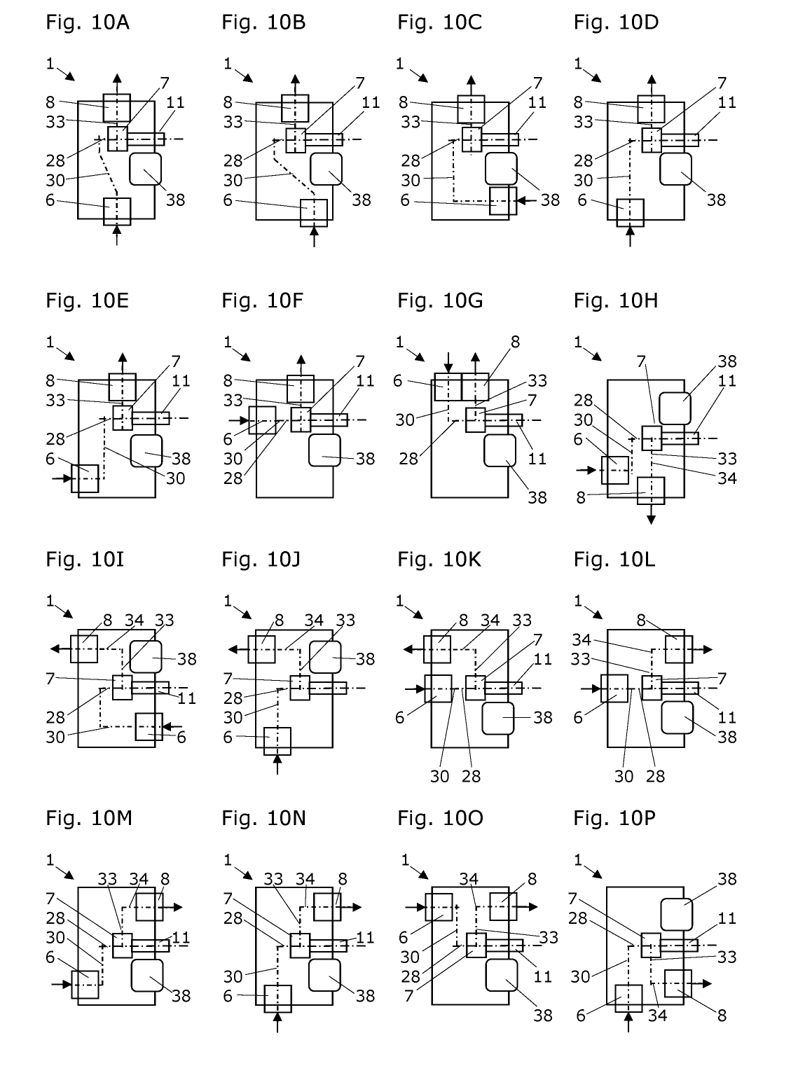

FIG. 10 shows a schematic illustration of a side view of 16 selected embodiments, wherein in:

FIG. 10A corresponding to the illustration in FIGS. 1 to 9, the water drain channel portion is arranged coaxially in relation to the water supply channel portion;

FIG. 10B the water drain channel portion is arranged axially parallel in relation to the water supply channel portion;

FIG. 10C the water drain channel portion is arranged angled in relation to the water supply channel portion;

FIG. 10D the water drain channel portion is arranged axially parallel in relation to the water supply channel portion

FIG. 10E the water drain channel portion is arranged angled in relation to the water supply channel portion;

FIG. 10F the water drain channel portion is arranged angled in relation to the water supply channel portion;

FIG. 10G the water drain channel portion is arranged axially parallel in relation to the water supply channel portion;

FIG. 10H the water drain channel portion is arranged angled in relation to the water supply channel portion;

FIG. 10I the water drain channel portion is arranged axially parallel in relation to the water supply channel portion;

FIG. 10J the water drain channel portion is arranged angled in relation to the water supply channel portion;

FIG. 10K the water drain channel portion is arranged axially parallel in relation to the water supply channel portion;

FIG. 10L the water drain channel portion is arranged axially parallel in relation to the water supply channel portion;

FIG. 10M the water drain channel portion is arranged axially parallel in relation to the water supply channel portion;

FIG. 10N the water drain channel portion is arranged angled in relation to the water supply channel portion;

FIG. 10O the water drain channel portion is arranged coaxially in relation to the water supply channel portion;

FIG. 10P the water drain channel portion is arranged angled in relation to the water supply channel portion;

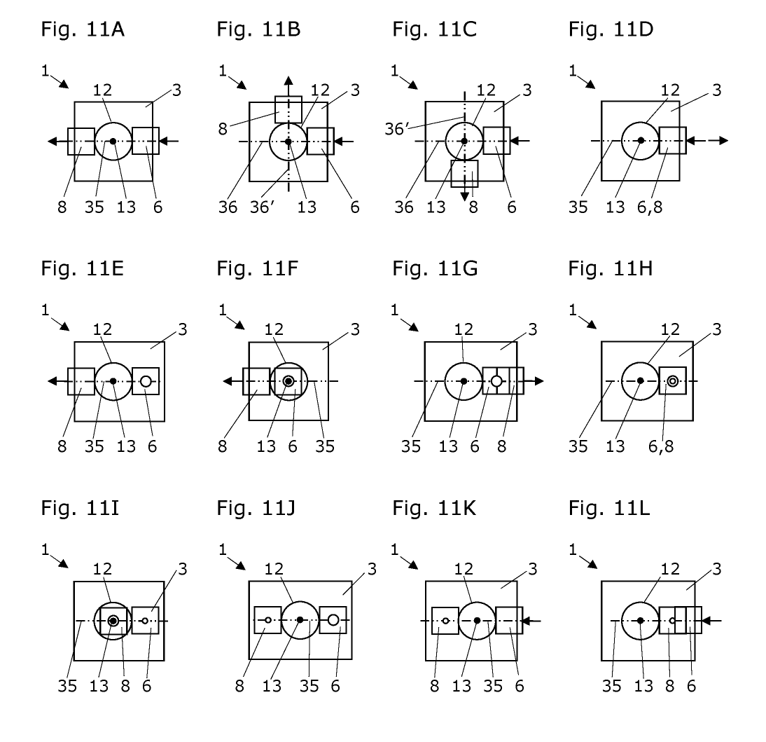

FIG. 11 shows a schematic illustration in a top view of 12 selected embodiments, wherein in:

FIG. 11A corresponding to the illustration in FIGS. 1 to 9, the water supply channel portion and the water drain channel portion are arranged in a plane common with the bore axis and coaxially;

FIG. 11B the water drain channel portion and the water supply channel portion are arranged in two planes intersecting the bore axis and in an angled manner;

FIG. 11C the water drain channel portion and the water supply channel portion are arranged in two planes intersecting the bore axis and in an angled manner;

FIG. 11D the water supply channel portion and the water drain channel portion are arranged in a plane common with the bore axis and axially parallel;

FIG. 11E the water supply channel portion and the water drain channel portion are arranged in a plane common with the bore axis and in an angled manner;

FIG. 11F the water supply channel portion and the water drain channel portion are arranged in a plane common with the bore axis and in an angled manner;

FIG. 11G the water supply channel portion and the water drain channel portion are arranged in a plane common with the bore axis and in an angled manner;

FIG. 11H the water supply channel portion and the water drain channel portion are arranged in a plane common with the bore axis and coaxially;

FIG. 11I the water supply channel portion and the water drain channel portion are arranged in a plane common with the bore axis and axially parallel;

FIG. 11J the water supply channel portion and the water drain channel portion are arranged in a plane common with the bore axis and axially parallel;

FIG. 11K the water supply channel portion and the water drain channel portion are arranged in a plane common with the bore axis and in an angled manner;

FIG. 11L the water supply channel portion and the water drain channel portion are arranged in a plane common with the bore axis and in an angled manner.

The control valve according to the invention will now be explained in detail on the basis of the appended figures and with reference to selected embodiments, which do not restrict the scope of the present invention.

FIG. 1 shows a vertical longitudinal section through a standing control valve 1 according to a first embodiment in a closed state, wherein the water supply channel portion 6 and the water drain channel portion 8 are arranged in a plane 35 common with the bore axis 13, and wherein the outflow bore 33 and the water drain channel portion 8 are arranged coaxially to one another. This valve 1 for controlling the water flow in a sanitary line 2, in a heating line 2′, or in a cooling line 2″ comprises a housing 3 having a housing lower part 4 and a housing upper part 5. In this case, a water supply channel portion 6 and, downstream thereof in the flow direction, a control channel 7 and a water drain channel portion 8 are arranged in the housing lower part 4.

The control valve 1 additionally comprises a valve upper part 9 having a headpiece 10 and a spindle 11. Such valve upper parts are known per se from the prior art and are routinely installed in gas fittings or sanitary fittings (cf. in this regard, for example, EP 0 335 997 B1). The headpiece 10 is at least partially arranged in a housing bore 12 coaxially to the bore axis 13 thereof, wherein the spindle 11 is arranged so it is radially rotatable in a headpiece bore 14 coaxial to the housing bore 12. The headpiece 10 additionally comprises a wall 15, which partially encloses the spindle 11 and which is arranged so it engages in the control channel 7 of the control valve 1.

As is typical for such a valve upper part 9, it comprises a stator disk 16, which is fastened on the headpiece 10, having at least one through-flow opening 17 penetrating this first valve disk 16 and having a first ceramic surface 18. This stator disk 16 can (as shown here) consist entirely of ceramic material and is arranged here in the control channel 7 coaxially to the headpiece bore 14. Alternatively, this stator disk 16 can also consist of a metal, a plastic, or a composite material, wherein all alternative stator disks 16 also have to comprise such a first ceramic surface 18, independently of further materials which are present.

Furthermore, the valve part 9 comprises a rotor disk 19, which is arranged in the control channel 7 coaxially to the headpiece bore 14 and is engaged with the spindle 11, having at least one through-flow opening 20 which penetrates this second valve disk 19 and having a second ceramic surface 21 arranged downstream from the stator disk 16. This rotor disk 19 can (as shown here) consist entirely of ceramic material and is arranged here in the control channel 7 coaxially to the headpiece bore 14. Alternatively, this rotor disk 19 can also consist of a metal, a plastic, or a composite material, wherein all rotor disks 19 also have to comprise such a second ceramic surface 21, independently of further materials which are present.

The second ceramic surface 21 of the rotor disk 19 lies so it is axially rotatable on the first ceramic surface 18 of the stator disk 16, as is also typical for such valve upper parts 9. The low risk of soiling of the ceramic surfaces 18, 21, which permanently slide on one another, the relatively small rotational angle of approximately 90° required for completely opening or closing the valve, and the short time span linked thereto, which is required for completely opening or closing the valve, are the great advantages of such valve upper parts 9 sealed by means of ceramic surfaces 18, 21.

The control valve 1 additionally comprises an electrical drive 22, which is arranged in the housing upper part 5 and is engaged with the spindle 11 of the valve upper part 9. A first circumferential seal 23 of the headpiece 10 presses against a surface 24 of this housing bore 12 to form a seal and a second circumferential seal 25 of the spindle 11 presses against an inner surface 26 of the headpiece bore 14 to form a seal such that these seals 23, 25 seal off the control channel 7 of the control valve 1 in relation to the housing upper part 5. The headpiece wall 15 comprises at least one window 27, which is arranged in the region of the control channel 7 and which is oriented, opposite to the water drain channel portion 8, toward the surface 24 of the housing bore 12, wherein when the control valve 1 is open, complete flushing through of the control channel 7 is ensured.

It is apparent to a person skilled in the art upon observation of FIG. 1 that the control valve 1 is shown here in the closed state. He sees this from the fact that the valve disk 19 designed as a rotor disk is shown in its cross section, which does not display a through-flow opening 20. A comparable position of this rotor disk 19 is shown in FIG. 7. In this position of the rotor disk 19, the through-flow openings 17 of the stator disk 16 are covered; the ceramic valve comprising the two valve disks 16, 19 is therefore closed. In addition, the two windows 27 are substantially concealed by the rotor disk 19. Because no water flows through this control valve 1, only the inflow side, i.e., the opening of the water supply channel portion 6 or the transition from the sanitary line 2, the heating line 2′, or the cooling line 2″ into the water supply channel portion 6 of the control valve 1 is identified with an arrow.

FIG. 2 shows a vertical longitudinal section through the standing control valve 1 of FIG. 1 in an open state. It is apparent to a person skilled in the art upon observation of FIG. 2 that the control valve 1 is shown here in the open state. He sees this from the fact that the valve disk 19 designed as a rotor disk is shown in its cross section, which displays two through-flow openings 20. A comparable position of this rotor disk 19 is shown in FIG. 8. In this position of the rotor disk 19, the through-flow openings 20 thereof are in register one over another with the through-flow openings 17 of the stator disk 16; the ceramic valve comprising the two valve disks 16, 19 is therefore open. The two open windows 27 are well visible here, which are not concealed by the rotor disk 19. The water flow through the open control valve 1 is shown by dashed lines. Because water can flow through this control valve 1, the inflow side and the outflow side, i.e., the openings of the water supply channel portion 6 and the water drain channel portion 8 or the transitions between sanitary line 2, heating line 2′, or cooling line 2″ and control valve 1 are each identified with an arrow.

FIG. 2 shows the same first embodiment of the control valve 1 according to the present invention as FIG. 1. The elements shown in FIG. 2 are therefore the same as in FIG. 1, so that here—except for the state of the valve opening—the same statements already made apply.

The following definitions apply in the meaning of the present invention: A window 27 is opposite to the water drain channel portion 8 if the largest part of the window opening, seen from the water drain channel portion 8, is located behind a plane which extends through the bore axis 13 and perpendicularly to the axis of the water drain channel portion 8. The location or the level of the seal 23 is assumed as the boundary between the housing lower part 4 and the housing upper part 5, because this seal 23 delimits the control channel 7 in relation to the housing upper part 5.

The first circumferential seal 23 of the headpiece 10 preferably presses without a gap against the surface 24 of the housing bore 12; independently thereof or in combination therewith, it is preferable for the second circumferential seal 25 of the spindle 11 to press without a gap against the inner surface 26 of the headpiece bore 14. Preferably the first seal 23 presses against the surface 24 of the housing bore 12 in the immediate vicinity of the water drain channel portion 8.

Preferably, the control valve 1 comprises an inflow bore 28, which is arranged coaxially to the housing bore 12; independently thereof or in combination therewith, this housing bore 12 preferably adjoins the water supply channel portion 6 downstream and is connected to the control channel 7 via a shoulder 29. The control valve 1 preferably additionally comprises a first through-flow channel 30, which connects the water supply channel portion 6 to the inflow bore 28.

It is particularly preferable for the stator disk 16 of the control valve 1 to be fastened in the headpiece bore 14 by means of a ring seal 32, which is pressed through a terminal opening 31 in the headpiece wall 15, in the headpiece 10 of the valve upper part 9. In addition, it is preferable for the ring seal 32 to be applied to the shoulder 29 to form a seal and therefore to seal off the control channel 7 in relation to the inflow bore 28.

The control valve 1 according to the invention preferably comprises an outflow bore 33, which is arranged perpendicularly to the housing bore 12 and adjoining upstream from the water drain channel portion 8 and is connected to the control channel 7. Depending on the design of the control valve 1, it can comprise a second through-flow channel 34, which connects the outflow bore 33 to the water drain channel portion 8. The first seal 23 preferably presses against the surface 24 of the housing bore 12 in the immediate vicinity of the outflow bore 33.

According to one selected embodiment of the control valve 1 according to the invention, the water drain channel portion 8 is preferably arranged coaxially, axially parallel, or angled in relation to the water supply channel portion 6 (cf. entire FIG. 10). On the one hand, it can be provided in this case that the inflow bore 28, the housing bore 12, and the water supply channel portion 6 are arranged coaxially to one another (cf. FIGS. 10F, 10K, and 10L). On the other hand, it can be provided in this case that the outflow bore 33 and the water drain channel portion 8 are arranged coaxially to one another (cf. FIGS. 10A to 10H). It is especially preferable for the inflow bore 28 to be arranged coaxially to the housing bore 12 and the control channel 7. It is also especially preferable for the outlet bore 33 to be arranged perpendicularly to the housing bore 12 and also to the control channel 7 (cf. FIGS. 10A to 10P).

A further embodiment of the control valve 1 according to the invention is defined in that the water supply channel portion 6 and the water drain channel portion 8 are arranged in a plane 35 common with the bore axis 13 (cf. FIGS. 11A and 11D to 11L). An alternative embodiment of the control valve 1 according to the invention is defined in that the water drain channel portion 8 and the water supply channel portion 6 are arranged in two planes 36, 36′ intersecting in the bore axis 13 (cf. FIGS. 11B and 11C).

A control valve 1 is preferred in which the electrical drive 22 is engaged via a transmission 37 with the spindle 11 of the valve upper part 9. It is particularly preferable for the electrical drive 22 to comprise a stepping motor 38 and an emergency power source 39. This emergency power source 39 can be designed, for example, as a battery, a rechargeable battery, a capacitor, or as a combination of these electrical components.

As shown in FIGS. 1 and 2, in the preferred first embodiment of the control valve 1 according to the invention, the headpiece 10 comprises at least two windows 27 distributed uniformly on the circumference, of which one (the one shown on the right side of the bore axis 13) is oriented, opposite to the water drain channel portion 8, toward the surface 24 of the housing bore 12 and ensures complete flushing through of the control channel 7 to avoid dead volumes when the control valve 1 is open.

The control valve 1 preferably comprises a temperature sensor 40, which is designed to measure the water temperature and is connected to a temperature regulating unit 41. This temperature sensor 40 is preferably arranged in the control valve 1 to measure the water temperature. Two particularly preferred installation locations for the temperature sensor 40 are shown in FIGS. 1 and 2:
in a bore of the spindle 11 or
in a niche in the housing lower part.

Both installation locations ensure that the surface of the temperature sensor has intensive contact with water-conducting or water-contacting elements of the control valve 1 and can thus reliably measure the temperature of the water flowing through the control valve 1. This surface contact can be further improved using known means, such as heat conduction paste, etc. In addition, the bore in the spindle 11 can be formed deeper than shown, so that the temperature sensor 40 comes to rest closer to the surface of the spindle 11 which is in contact with water (particularly well visible in FIG. 2). The temperature sensor 40 preferably does not come into direct contact with water.

While the electrical lines for the temperature sensor 40, which is held stationary in the housing lower part niche, are not subjected to a torsion movement, flexible electrical lines are preferably used for the temperature sensor held rotatably in the spindle bore. The relatively small rotational angle of the spindle 11 of approximately 90°, which is necessary to completely open or close the control valve 1, does not represent a large technical obstacle in this case.

The control valve 1 according to the invention preferably comprises a flow sensor 42, which is designed to measure the water flow and is connected to a flow rate regulating unit 43. The flow sensor 42 is particularly preferably arranged in a through-flow channel 30, 34 or in a portion, arranged before or after the control valve 1, of the sanitary line 2, heating line 2′, or cooling line 2″. In FIGS. 1 and 2, the flow sensor 42 is shown as a propeller and is arranged in each case in the first through-flow channel 30.

To securely close the control valve 1 in relation to the environment, it preferably comprises a cover 45 for terminating the housing upper part 5. The temperature regulating unit 41 and/or the flow rate regulating unit 43 are preferably arranged on a printed circuit board 44 in the housing upper part 5 or in the cover 45 of the valve 1.

An introduction point for electrical lines (cf. lightning symbols) is shown in FIGS. 1 and 2 in the region of the cover 45. This line introduction point is preferably equipped with a tension relieving element 52, as shown by way of example in FIG. 2.

The printed circuit board 44 having the electronic components for controlling the electric motor 38 is reasonably arranged in the immediate vicinity of this line introduction point in the cover 45. The electronic components of a possibly provided temperature regulating unit 41 and also an optional flow rate regulating unit 43 are preferably arranged on this printed circuit board 44.

FIG. 3 shows a partially cutaway 3D illustration of the control valve 1 of FIG. 1 in a closed state, viewed from above. The housing 3 and the cover 45 of the control valve 1 are visible and shown. A scale 47 of the temperature regulating unit 41 is depicted on the cover. A selection wheel 46 of the temperature regulating unit 41 is shown in FIG. 2, is operationally connected to the temperature controller 41, and is used for preselection of a selected water temperature, for example, by setting a pointer to a determined temperature value of the scale 47.

In FIG. 3, the flow sensor 42 is shown as a propeller and is arranged in the portion of the sanitary line 2, heating line 2′, or cooling line 2″ before the control valve 1 (cf. FIGS. 1 and 2). In the cutaway part of the control valve 1, the headpiece 10 of the valve upper part 9 and the headpiece wall 15 are shown. The valve disks 16, 19, which are pivoted toward one another to form a seal, are also visible. The through-flow opening 20 of the rotor disk 19 points here in a direction perpendicular to the outflow bore 33 and the water drain channel portion 8; it is apparent therefrom that the control valve 1 is closed. The headpiece wall 15 is held centered by webs 50 in the seat 49 (cf. FIG. 9). A directional cam 48 of the valve disk 16, which engages in a groove 51 (cf. FIGS. 1 and 2) and thus prevents this stator disk 16 from being able to change its location upon rotation of the rotor disk 19, is also visible. Because the control valve 1 is closed, only one flow arrow before the water supply channel portion 6 is shown.

FIG. 4 shows a partially cutaway 3D illustration of the control valve 1 of FIG. 2 in an open state, viewed from above. The housing 3 and the cover 45 of the control valve 1 are visible and shown. As in FIG. 3, a scale 47 of the temperature regulating unit 41 is depicted on the cover.

In FIG. 4, the flow sensor 42 is shown as a propeller and is arranged in the portion of the sanitary line 2, heating line 2′, or cooling line 2″ after the control valve 1 (cf. FIGS. 1 and 2). The headpiece 10 of the valve upper part 9 and the headpiece wall 15 are shown in the cutaway part of the control valve 1. The opposing valve disks 16, 19 having the through-flow openings 17, 20 arranged in register one over another are also visible. The through-flow opening 20 of the rotor disk 19 points here in a direction facing axially-parallel to the outflow bore 33 and the water drain channel portion 8; it is apparent therefrom that the control valve 1 is open. The headpiece wall 15 is held centered by webs 50 in the seat 49 (cf. FIG. 9). A directional cam 48 of the valve disk 16, which engages in a groove 51 (cf. FIGS. 1 and 2) and thus prevents this stator disk 16 from being able to change its location upon rotation of the rotor disk 19, is also visible. Because the control valve 1 is open, a flow arrow is shown in each case before the water supply channel portion 6 and after the water drain channel portion 8.

FIG. 5 shows a horizontal longitudinal partial section through the closed control valve 1 of FIGS. 1 and 3 with section guide shown for FIG. 1 (cf. double arrow 1-1). The common plane 35, in which the water supply channel portion 6, the water drain channel portion 8, and also the bore axis 13 are all arranged is visible and shown. The seat 49 for holding and centering the headpiece wall 15 of the valve upper part 9 in the housing lower part 4 of the control valve 1 according to the invention is marked with curved brackets. Multiple (at least three) webs 50, which actually exercise the seat function with little play in relation to the headpiece wall 15 of the valve upper part 9, are arranged around this seat 49. The control channel 7 comprises the entire seat 49 having its webs 50 and the regions 50′ located between each two webs 50. If a web 50 is provided in the region of the water drain channel portion 8 (as shown) or in the region of the outflow bore 33, this web 50 preferably has a narrow shape to impair the water flow as little as possible (as shown).

If, for example, a seat 49 having three webs 50 is provided, advantageously none of the webs 50 is arranged in the region of the water drain channel portion 8 or in the region of the outflow bore 33; in this case, one web 50 is preferably located in the region of the common plane 35 on the side of the housing bore 12 opposite to the channel portion 8 or the outflow bore 33. This arrangement of the web 50 additionally has the advantage that with open control valve 1, the water flow from the window 27 of the valve upper part 9 is conducted divided in two and into the regions 50′ located on the left and right of the web 50 (cf. FIG. 6). Complete flushing through of the control channel 7 is also ensured in this case to avoid dead volumes.

The through-flow openings 20 of the rotor disk 19 point here in a direction facing perpendicularly to the water drain channel portion 8; it is apparent therefrom that the control valve 1 is closed. The first ceramic surface 18 of the stator disk 16 is visible in the regions of the through-flow openings 20 of the rotor disk 19. Two directional cams 48, which are comprised by the stator disk 16, and fix the stator disk 16 in its location, are also visible here.

FIG. 6 shows a horizontal longitudinal partial section through the open control valve 1 of FIGS. 2 and 4 with section guide shown for FIG. 2 (cf. double arrow 2-2). The through-flow openings 20 of the rotor disk 19 lie here in the common plane 35 and point directly toward the water drain channel portion 8 or in the opposite direction. The through-flow openings 20 of the rotor disk 19 are located here directly above the through-flow openings 17 of the stator disk 16; it is apparent therefrom that the control valve 1 is open. Two directional cams 48, which are comprised by the stator disk 16, and which fix the stator disk 16 in its location, are also well visible here. The further statements on FIG. 5 also apply accordingly to FIG. 6, so that—except for the following remarks—a repetition will be omitted.

FIG. 6 shows an arrangement of one web 50 in the region of the common plane 35 on the side of the housing bore 12 opposite to the water drain channel portion 8 or the outflow bore 33. In this web arrangement, the window 27 of the valve upper part 9, which is arranged on the opposite side of the housing bore 12 in relation to the water drain channel portion 8 or the outflow bore 33, is oriented on this web 50. This has the advantage that with open control valve 1, the water flow from this window 27 is divided in two and (as shown) is conducted into the regions 50′ located on the left and right of the web 50. Complete flushing through of the control channel 7 is therefore ensured, so that dead volumes in the control channel 7 are avoided.

FIG. 7 shows a top view of the two valve disks 16, 19 with closed control valve 1 corresponding to FIGS. 1, 3, and 5. FIG. 7 is an enlarged illustration of the two valve disks 16, 19 shown in FIG. 5. The two directional cams 48, which are comprised by the stator disk 16 and which fix the stator disk 16 in its location in the valve upper part 9, are especially well visible here. The two directional cams 48 are arranged diametrically opposing on the circumference of the stator disk 16 and both lie in the common plane 35 (cf. FIG. 5). The through-flow openings 20 of the rotor disk 19 point here in a direction facing perpendicularly to the directional cams 48, the control valve 1 is closed. The first ceramic surface 18 of the stator disk 16 is visible in the regions of the through-flow openings 20 of the rotor disk 19.

FIG. 8 shows a top view of the two valve disks 16, 19 with open control valve corresponding to FIGS. 2, 4, and 6. FIG. 8 is an enlarged illustration of the two valve disks 16, 19 shown in FIG. 6. The two directional cams 48, which are comprised by the stator disk 16, and which fix the stator disk 16 in its location in the valve upper part 9, are especially well visible here. The through-flow openings 20 of the rotor disk 19 lie here in the common plane 35 (cf. FIG. 6) and point directly toward the two direction cams 48. The through-flow openings 20 of the rotor disk 19 are directly above the through-flow openings 17 of the stator disk 16 here, the control valve 1 is open.

Notwithstanding the illustration in FIGS. 1-8, only one or more than two directional cams 48 can also be used for fixing the stator disk 16 in the headpiece wall 15 of the valve upper part 9 (i.e., for preventing twisting of the valve disk 16). Two diametrically opposing directional cams 48 arranged on the outer circumference of the valve disks 16, which engage in correspondingly formed and arranged grooves 51 on the inner side of the headpiece wall 15, are preferred.

FIG. 9 shows a partially cutaway 3D illustration of the control valve 1 of FIG. 2 in the open state, viewed from below. The housing 3 and the cover 45 and also the outlet bore 33 and the water drain channel portion 8 of the control valve 1 are visible and shown. The headpiece 10 and the spindle 11 of the valve upper part 9 as well as the headpiece wall 15 thereof are shown in the cutaway part of the control valve 1. The two windows 27 and the terminal opening 31 in the headpiece wall 15 are also visible. In the window 27, which is oriented toward the outflow bore 33 and the water drain channel portion 8 of the control valve 1, the through-flow opening 20 of the rotor disk 19 of the open control valve 1 can be seen, the direction of the water flow is therefore marked with an arrow in the region of the water drain channel portion 8. The bore axis 13 of the housing bore 12 is marked and the first through-flow channel 30 and the inflow bore 28 having the shoulder 29 adjoining thereon are visible around the housing lower part 4.

The ring seal 32, which is pressed through the terminal opening 31 in the headpiece wall 15 and is applied to the stator disk 16, is also visible; this valve disk 16 is therefore fastened in the headpiece bore 14 of the valve upper part 9, so that it also cannot move in the direction of the bore axis 13. This ring seal 32 is applied to the shoulder 29 to form a seal and therefore seals off the control channel 7 in relation to the inflow bore 28. The seat 49 between the webs 50 is also marked, wherein the narrow web 50 is shown, which is arranged axially in the common plane 35 (cf. FIGS. 5, 6) and in the outflow bore 33.

FIG. 10 shows a schematic illustration of a side view of 16 selected embodiments of the control valve 1 according to the invention. All embodiments shown have a fundamentally identical arrangement of the inflow bore 28, the control channel 7, and the outflow bore 33, in that the inflow bore 28 and the control channel 7 are arranged coaxially to one another and to the bore axis 13 of the control valve 1, while the outflow bore 33 is always arranged perpendicularly to the bore axis 13 and therefore to the spindle 11. The 16 embodiments shown differ from one another by way of the individual arrangement thereof of the elements water supply channel portion 6, first through-flow channel 30, second through-flow channel 34, and water drain channel portion 8. In the selection of the 16 embodiments shown, depicting simply mirror-inverted variants was omitted; of course, these variants similar to mirror images are also within the scope of the present invention. The motor 38 for driving the spindle 11 is always located in the housing upper part 5 (cf. FIGS. 1, 2).

FIG. 10A shows, corresponding to the illustration in FIGS. 1 to 9, a first embodiment of the control valve 1 according to the invention, in which the water drain channel portion 8 is arranged coaxially in relation to the water supply channel portion 6. The water supply channel portion 6 and the water drain channel portion 8 are each arranged on opposite sides of the control valve 1, i.e., on both sides of the spindle 11. The first through-flow channel 30 extends at an angle in relation to the water supply channel portion 6 and adjoins the inflow bore 28 perpendicularly. The second through-flow channel 34 is practically not provided or is very short and is arranged coaxially to the water drain channel portion 8.

FIG. 10B shows a second embodiment of the control valve 1 according to the invention, in which the water drain channel portion 8 is arranged axially parallel in relation to the water supply channel portion 6. Water supply channel portion 6 and water drain channel portion 8 are each arranged on opposite sides of the control valve 1, i.e., on both sides of the spindle 11. The first through-flow channel 30 extends at an angle in relation to the water supply channel portion 6 and adjoins the inflow bore 28 perpendicularly. The second through-flow channel 34 is practically not provided or is very short and is arranged coaxially to the water drain channel portion 8.

FIG. 10C shows a third embodiment of the control valve 1 according to the invention, in which the water drain channel portion 8 is arranged at an angle in relation to the water supply channel portion 6. The water supply channel portion 6 is arranged on the upper side and the water drain channel portion 8 is arranged on one side of the control valve 1, i.e., on both sides of the spindle 11. The first through-flow channel 30 extends at an angle in relation to the water supply channel portion 6 and adjoins the inflow bore 28 perpendicularly. The second through-flow channel 34 is practically not provided or is very short and is arranged coaxially to the water drain channel portion 8.

FIG. 10D shows a fourth embodiment of the control valve 1 according to the invention, in which the water flow channel portion 8 is arranged axially parallel in relation to the water supply channel portion 6. The water supply channel portion 6 is arranged on one side and the water drain channel portion 8 is arranged on the other side of the control valve 1, i.e., on both sides of the spindle 11. The first through-flow channel 30 extends coaxially in relation to the water supply channel portion 6 and adjoins the inflow bore 28 perpendicularly. The second through-flow channel 34 is practically not provided or is very short and is arranged coaxially to the water drain channel portion 8.

FIG. 10E shows a fifth embodiment of the control valve 1 according to the invention, in which the water drain channel portion 8 is arranged at an angle in relation to the water supply channel 6. The water supply channel portion 6 is arranged on the lower side and the water drain channel portion 8 is arranged on one side of the control valve 1, i.e., on both sides of spindle 11. The first through-flow channel 30 extends at an angle in relation to the water supply channel portion 6 and adjoins the inflow bore 28 perpendicularly. The second through-flow channel 34 is practically not provided or is very short and is arranged coaxially to the water drain channel portion 8.

FIG. 10F shows a sixth embodiment of the control valve 1 according to the invention, in which the water drain channel portion 8 is arranged at an angle in relation to the water supply channel portion 6. The water supply channel portion 6 is arranged on the lower side and the water drain channel portion 8 is arranged on one side of the control valve 1, i.e., not on both sides of the spindle 11. The first through-flow channel 30 extends coaxially in relation to the water supply channel portion 6 and coaxially adjoins the inflow bore 28. The second through-flow channel 34 is practically not provided or is very short and is arranged coaxially to the water drain channel portion 8.

FIG. 10G shows a seventh embodiment of the control valve 1 according to the invention, in which the water drain channel portion 8 is arranged axially parallel in relation to the water supply channel portion 6. The water supply channel portion 6 is arranged on the same side of the control valve 1 as the water drain channel portion 8, i.e., on one side of the spindle 11. The first through-flow channel 30 extends coaxially in relation to the water supply channel portion 6 and adjoins the inflow bore 28 perpendicularly. The second through-flow channel 34 is practically not provided or is very short and is arranged coaxially to the water drain channel portion 8.

FIG. 10H shows an eighth embodiment of the control valve 1 according to the invention, in which the water drain channel portion 8 is arranged at an angle in relation to the water supply channel portion 6. The water supply channel portion 6 is arranged on the lower side and the water drain channel portion 8 is arranged on one side of the control valve 1, i.e., on one side of the spindle 11. The first through-flow channel 30 extends at an angle in relation to the water supply channel portion 6 and adjoins the inflow bore 28 perpendicularly. The second through-flow channel 34 is arranged coaxially to the water drain channel portion 8.

FIG. 10I shows a ninth embodiment of the control valve 1 according to the invention, in which the water drain channel portion is arranged axially parallel in relation to the water supply channel portion. The water supply channel portion 6 is arranged on the upper side and the water drain channel portion 8 is arranged on the lower side of the control valve 1, i.e., on both sides of the spindle 11. The first through-flow channel 30 extends at an angle in relation to the water supply channel portion 6 and adjoins the inflow bore 28 perpendicularly. The second through-flow channel 34 is arranged at an angle in relation to the water drain channel portion 8.

FIG. 10J shows a tenth embodiment of the control valve 1 according to the invention, in which the water drain channel portion 8 is arranged at an angle in relation to the water supply channel portion 6. The water supply channel portion 6 is arranged on one side and the water drain channel portion 8 is arranged on the lower side of the control valve 1, i.e., on both sides of the spindle 11. The first through-flow channel 30 extends coaxially in relation to the water supply channel portion 6 and adjoins the inflow bore 28 perpendicularly. The second through-flow channel 34 is arranged at an angle in relation to the water drain channel portion 8.

FIG. 10K shows an eleventh embodiment of the control valve 1 according to the invention, in which the water drain channel portion 8 is arranged axially parallel in relation to the water supply channel portion 6. The water supply channel portion 6 and the water drain channel portion 8 are arranged on the lower side of the control valve 1, i.e., not on both sides of the spindle 11. The first through-flow channel 30 extends coaxially in relation to the water supply channel portion 6 and adjoins the inflow bore 28 coaxially. The second through-flow channel 34 is arranged at an angle in relation to the water drain channel portion 8.

FIG. 10L shows a twelfth embodiment of the control valve 1 according to the invention, in which the water drain channel portion 8 is arranged axially parallel in relation to the water supply channel portion 6. The water supply channel portion 6 is arranged on the lower side and the water drain channel portion 8 is arranged on the upper side of the control valve 1, i.e., not on both sides of the spindle 11. The first through-flow channel 30 extends coaxially in relation to the water supply channel portion 6 and adjoins the inflow bore 28 coaxially. The second through-flow channel 34 is arranged at an angle in relation to the water drain channel portion 8.

FIG. 10M shows a thirteenth embodiment of the control valve 1 according to the invention, in which the water drain channel portion 8 is arranged axially parallel in relation to the water supply channel portion 6. The water supply channel portion 6 is arranged on the lower side and the water drain channel portion 8 is arranged on the upper side of the control valve 1, i.e., on both sides of the spindle 11. The first through-flow channel 30 extends at an angle in relation to the water supply channel portion 6 and adjoins the inflow bore 28 perpendicularly. The second through-flow channel 34 is arranged at an angle in relation to the water drain channel portion 8.

FIG. 10N shows a fourteenth embodiment of the control valve 1 according to the invention, in which the water drain channel portion 8 is arranged at an angle in relation to the water supply channel portion 6. The water supply channel portion 6 is arranged on one side and the water drain channel portion 8 is arranged on the upper side of the control valve 1, i.e., on both sides of the spindle 11. The first through-flow channel 30 extends coaxially in relation to the water supply channel portion 6 and adjoins the inflow bore 28 perpendicularly. The second through-flow channel 34 is arranged at an angle in relation to the water drain channel portion 8.

FIG. 10O shows a fifteenth embodiment of the control valve 1 according to the invention, in which the water drain channel portion 8 is arranged coaxially in relation to the water supply channel portion 6. The water supply channel portion 6 is arranged on the lower side and the water drain channel portion 8 is arranged on the upper side of the control valve 1, i.e., on one side of the spindle 11. The first through-flow channel 30 extends at an angle in relation to the water supply channel portion 6 and adjoins the inflow bore 28 perpendicularly. The second through-flow channel 34 is arranged at an angle in relation to the water drain channel portion 8.

FIG. 10P shows a sixteenth embodiment of the control valve 1 according to the invention, in which the water drain channel portion is arranged at an angle in relation to the water supply channel portion. The water supply channel portion 6 is arranged on one side and the water drain channel portion 8 is arranged on the upper side of the control valve 1, i.e., on one side of the spindle 11. The first through-flow channel 30 extends coaxially in relation to the water supply channel portion 6 and adjoins the inflow bore 28 perpendicularly. The second through-flow channel 34 is arranged at an angle in relation to the water drain channel portion 8.

FIG. 11 shows a schematic illustration of a top view of 12 selected embodiments of the control valve 1 according to the invention. All 12 embodiments shown correspond to those which are shown in FIG. 10. Therefore, it is also true here that all 12 embodiments have a fundamentally identical arrangement of the inflow bore 28, the control channel 7, and the outflow bore 33, in that the inflow bore 28 and the control channel 7 are arranged coaxially to one another and to the bore axis 13 of the control valve 1, while the outflow bore 33 is always arranged perpendicularly to the bore axis 13 and therefore to the spindle 11. The 12 embodiments shown differ from one another by way of the individual arrangement thereof of the elements water supply channel portion 6, first through-flow channel 30, second through-flow channel 34, and water drain channel portion 8. In the selection of the 12 embodiments shown, depicting simply mirror-inverted variants was omitted; of course, these mirror-image variants are also within the scope of the present invention. The water supply channel portion 6 is marked in each case with an arrow facing toward the control valve 1 or with a large empty circle. The water drain channel portion 8 is marked in each case with an arrow facing away from the control valve 1 or with a small empty circle. The bore axis 13 is marked in each case with a black dot.

FIG. 11A shows the first embodiment of the control valve 1 according to the invention corresponding to the illustration in FIGS. 1 to 9. The water supply channel portion 6 and the water drain channel portion 8 are arranged in a plane 35 common with the bore axis 13 and coaxially on both sides of the bore 12 on the housing 3 (cf. FIG. 10A). Moreover, the second and fourth embodiments are also shown here, in which the water supply channel portion 6 and the water drain channel portion 8 are arranged in a plane common with the bore axis 13 and axially parallel on both sides of the bore 12 on the housing 3 (cf. FIGS. 10B, 10D).

FIG. 11B shows a first variant of the first, second, or fourth embodiment of the control valve 1 according to the invention (cf. FIGS. 10A, 10B, 10D), in which the water drain channel portion 8 and the water supply channel portion 6 are arranged in two planes 36, 36′, which intersect in the bore axis 13, and angled counterclockwise.

FIG. 11C shows a second variant of the first, second, or fourth embodiment of the control valve 1 according to the invention (cf. FIG. 10A, 10B, or 10D), in which the water drain channel portion 8 and the water supply channel portion 6 are arranged in two planes 36, 36′, which intersect in the bore axis 13, and angled clockwise.

FIG. 11D shows the seventh embodiment of the control valve 1 according to the invention corresponding to the illustration in FIG. 10G. The water supply channel portion 6 and the water drain channel portion 8 are arranged in a plane 35 common with the bore axis 13 and axially parallel or coaxially on one side of the bore 12 on the housing 3.

FIG. 11E shows the third or fifth embodiment of the control valve 1 according to the invention corresponding to the illustration in FIG. 10C or 10E, respectively. The water supply channel portion 6 and the water drain channel portion 8 are arranged in a plane 35 common with the bore axis 13 and angled on both sides of the bore 12 on the housing 3.

FIG. 11F shows the sixth embodiment of the control valve 1 according to the invention corresponding to the illustration in FIG. 10F. The water supply channel portion 6 and the water drain channel portion 8 are arranged in a plane 35 common with the bore axis 13 and angled to one another and coaxially to or on one side of the bore 12 on the lower side or upper side of the housing 3.

FIG. 11G shows the eighth embodiment of the control valve 1 according to the invention corresponding to the illustration in FIG. 10H. The water supply channel portion 6 and the water drain channel portion 8 are arranged in a plane 35 common with the bore axis 13 and angled to one another and on one side of the bore 12 on the housing 3.

FIG. 11H shows the fifteenth embodiment of the control valve 1 according to the invention corresponding to the illustration in FIG. 10O. The water supply channel portion 6 and the water drain channel portion 8 are arranged coaxially to one another in a plane 35 common with the bore axis 13 and on one side of the bore 12 on the housing 3.

FIG. 11I shows the eleventh and twelfth embodiments of the control valve 1 according to the invention corresponding to the illustration in FIGS. 10K and 10L. The water supply channel portion 6 and the water drain channel portion 8 are arranged in a plane 35 common with the bore axis 13, axially parallel to one another and coaxially to or on one side of the bore 12 on the housing 3.

FIG. 11J shows the ninth and thirteenth embodiments of the control valve 1 according to the invention corresponding to the illustration in FIGS. 10I and 10M. The water supply channel portion 6 and the water drain channel portion 8 are arranged in a plane 35 common with the bore axis 13, axially parallel to one another, and on both sides of the bore 12 on the housing 3.

FIG. 11K shows the tenth and fourteenth embodiments of the control valve 1 according to the invention corresponding to the illustration in FIGS. 10J and 10N. The water supply channel portion 6 and the water drain channel portion 8 are arranged in a plane 35 common with the bore axis 13, angled to one another, and on both sides of the bore 12 on the housing 3.

FIG. 11L shows the sixteenth embodiment of the control valve 1 according to the invention corresponding to the illustration in FIG. 10P. The water supply channel portion 6 and the water drain channel portion 8 are arranged in a plane 35 common with the bore axis 13, angled to one another, and on one side of the bore 12 on the housing 3.

Combinations of the embodiments shown and/or described of the control valve 1 according to the invention are within the scope of the present invention, even if they are not described in detail. The same reference signs indicate corresponding elements, even if they have not been described in detail in each case.

The control valve 1 according to the invention can be used in manifold ways; in particular, the embodiments according to FIGS. 10A and 10O are suitable for installation in a straight line, whether this is a sanitary line 2, a heating line 2′, or a cooling line 2″. When suitably positioned, all other embodiments of the control valve 1 according to the invention are also suitable for installation in a sanitary line 2, a heating line 2′, or a cooling line 2″. Accordingly, a sanitary installation having at least one sanitary line 2, a heating installation having at least one heating line 2′, and also a cooling installation having at least one cooling line 2″ can each comprise at least one control valve 1 according to the invention.

The embodiments according to FIGS. 10C, 10E, 10F, 10H, 10J, 10N, and 10P are especially suitable as angled valves having a common plane 35; thereof, the embodiments according to FIGS. 10F, 10H, and 10P are especially preferred because of the compact construction thereof. It is to be expressly noted here that practically all disclosed embodiments of the control valve 1 according to the invention (cf. FIG. 10) are suitable for use as angle valves, if they are embodied, according to the variants corresponding to FIG. 11B or 11C, as angle valves having two intersecting planes 36, 36′.

### LIST OF REFERENCE NUMERALS

1 valve, control valve
2 sanitary line
2′ heating line
2″ cooling line
3 housing
4 housing lower part
5 housing upper part
6 water supply channel portion
7 control channel
8 water drain channel portion
9 valve upper part
10 headpiece of 9
11 spindle of 9
12 housing bore, bore in 3
13 bore axis of 12
14 headpiece bore
15 wall of 10, headpiece wall
16 stator disk, first valve disk
17 through-flow opening of 16
18 first ceramic surface of 16
19 rotor disk, second valve disk
20 through-flow opening of 19
21 second ceramic surface of 19
22 electrical drive
23 first circumferential seal of 10
24 surface of 12
25 second circumferential seal of 11
26 inner surface of 14
27 window
28 inflow bore
29 shoulder
30 first through-flow channel
31 terminal opening of 15
32 ring seal
33 outflow bore
34 second through-flow channel
35 common plane
36, 36′ intersecting planes
37 transmission
38 stepping motor, drive motor
39 emergency power source
40 temperature sensor
41 temperature regulating unit
42 flow sensor
43 flow rate regulating unit
44 printed circuit board
45 cover
46 selection wheel of 41
47 scale of 41
48 directional cam of 16
49 seat
50 web of 49
50′ region between two webs 50
51 groove for 48
52 tension relief element

1. A valve (1) for controlling the water flow in a sanitary line (2), comprising:
a) a housing (3) having a housing lower part (4) and a housing upper part (5), wherein a water supply channel portion (6) and, downstream thereof, a control channel (7) and a water drain channel portion (8) are arranged in the housing lower part (4),
characterized in that the control valve (1) additionally comprises:
b) a valve upper part (9) having a headpiece (10) and a spindle (11), wherein the headpiece (10) is at least partially arranged in a housing bore (12) coaxially to the bore axis (13) thereof, wherein the spindle (11) is arranged so it is radially rotatable in a headpiece bore (14) coaxial to the housing bore (12), and wherein the headpiece (10) comprises a wall (15), which partially encloses the spindle (11) and which is arranged engaging in the control channel (7) of the control valve (1);
c) a stator disk (16), which is arranged coaxially to the headpiece bore (14) in the control channel (7) and is fastened on the headpiece (10), having at least one through-flow opening (17) penetrating this first valve disk (16) and having a first ceramic surface (18);
d) a rotor disk (19), which is arranged coaxially to the headpiece bore (14) in the control channel (7) and is engaged with the spindle (11), having at least one through-flow opening (20) penetrating this second valve disk (19) and having a second ceramic surface (21), which is arranged downstream from the stator disk (16), and which lies so it is axially rotatable on the first ceramic surface (18) of the stator disk (16); and
e) an electrical drive (22), which is arranged in the housing upper part (5) and is engaged with the spindle (11) of the valve upper part (9),
wherein a first circumferential seal (23) of the headpiece (10) presses against a surface (24) of this housing bore (12) to form a seal and a second circumferential seal (25) of the spindle (11) presses against an inner surface (26) of the headpiece bore (14) to form a seal, so that these seals (23, 25) seal off the control channel (7) of the control valve (1) in relation to the housing upper part (5),
and wherein the headpiece wall (15) comprises at least one window (27) arranged in the region of the control channel (7), which is oriented, opposite to the water drain channel portion (8), toward the surface (24) of the housing bore (12), whereby complete flushing through of the control channel (7) is ensured when the control valve (1) is open.

2. The control valve (1) according to claim 1, characterized in that the first circumferential seal (23) of the headpiece (10) presses against the surface (24) of the housing bore (12) without a gap.

3. The control valve (1) according to claim 1, characterized in that the second circumferential seal (25) of the spindle (11) presses against the inner surface (26) of the headpiece bore (14) without a gap.

4. The control valve (1) according to any one of claim 1, 2, or 3, characterized in that it comprises an inflow bore (28), which is arranged coaxially to the housing bore (12).

5. The control valve (1) according to claim 4, characterized in that the inflow bore (28) is connected adjoining the water supply channel portion (6) downstream and to the control channel (7) via a shoulder (29).

6. The control valve (1) according to claim 4, characterized in that it comprises a first through-flow channel (30), which connects the water supply channel portion (6) to the inflow bore (28).

7. The control valve (1) according to any one of the preceding claims, characterized in that the stator disk (16) is fastened in the headpiece bore (14) by means of a ring seal (32), which is pressed through a terminal opening (31) in the headpiece wall (15), in the headpiece (10).

8. The control valve (1) according to claim 7, characterized in that the ring seal (32) is applied to the shoulder (29) to form a seal and therefore seals off the control channel (7) in relation to the inflow bore (28).

9. The control valve (1) according to any one of the preceding claims, characterized in that it comprises an outflow bore (33), which is arranged perpendicularly to the housing bore (12) and adjoining the water drain channel portion (8) upstream and is connected to the control valve (7).

10. The control valve (1) according to claim 9, characterized in that it comprises a second through-flow channel (34), which connects the outflow bore (33) to the water drain channel portion (8).

11. The control valve (1) according to any one of the preceding claims, characterized in that the water drain channel portion (8) is arranged coaxially, axially parallel, or angled in relation to the water supply channel portion (6).

12. The control valve (1) according to claim 11, characterized in that the inflow bore (28), the housing bore (12), and the water supply channel portion (6) are arranged coaxially to one another.

13. The control valve (1) according to claim 11, characterized in that the outflow bore (33) and the water drain channel portion (8) are arranged coaxially to one another.

14. The control valve (1) according to claim 11, characterized in that the inflow bore (28), the housing bore (12), and the water supply channel portion (6) are arranged coaxially to one another.

15. The control valve (1) according to any one of claims 11 to 14, characterized in that the water supply channel portion (6) and the water drain channel portion (8) are arranged in a plane (35) common with the bore axis (13).

16. The control valve (1) according to any one of claims 11 to 14, characterized in that the water drain channel portion (8) and the water supply channel portion (6) are arranged in two planes (36, 36′) intersecting in the bore axis (13).

17. The control valve (1) according to any one of the preceding claims, characterized in that the electrical drive (22) is engaged via a transmission (37) with the spindle (11) of the valve upper part (9).

18. The control valve (1) according to any one of the preceding claims, characterized in that the electrical drive (22) comprises a stepping motor (38) and an emergency power source (39).

19. The control valve (1) according to claim 18, characterized in that the emergency power source (39) is designed as a battery, a rechargeable battery, a capacitor, or a combination of these electrical components.

20. The control valve (1) according to any one of the preceding claims, characterized in that the headpiece (10) comprises at least two windows (27) distributed uniformly on the circumference, of which one is oriented, opposite to the water drain channel portion (8), toward the surface (24) of the housing bore (12) and, to avoid dead volumes, ensures complete flushing through of the control channel (7) when the control valve (1) is open.

21. The control valve (1) according to any one of the preceding claims, characterized in that it comprises a temperature sensor (40), which is designed to measure the water temperature and is connected to a temperature regulating unit (41).

22. The control valve (1) according to claim 21, characterized in that the temperature sensor (40) for measuring the water temperature is arranged in the control valve (1).

23. The control valve (1) according to any one of the preceding claims, characterized in that it comprises a flow sensor (42), which is designed to measure the water flow and is connected to a flow rate regulating unit (43).

24. The control valve (1) according to claim 23, characterized in that the flow sensor (42) is arranged in a through-flow channel (30, 34) or in a portion of the sanitary line (2) before or after the control valve (1).

25. The control valve (1) according to any one of the preceding claims, characterized in that it comprises a cover (45) for terminating the housing upper part (5).

26. The control valve (1) according to claims 21, 23, and 25, characterized in that the temperature regulating unit (41) and/or the flow rate regulating unit (43) are arranged on a printed circuit board (44) in the housing upper part (5) or in the cover (45).

27. A sanitary installation having at least one sanitary line (2), characterized in that the sanitary line (2) comprises a control valve (1) according to any one of claims 1 to 26.

28. A heating installation having at least one heating line (2′), characterized in that the heating line (2′) comprises a control valve (1) according to any one of claims 1 to 26.

29. A cooling installation having at least one cooling line (2″), characterized in that the cooling line (2′) comprises a control valve (1) according to any one of claims 1 to 26.
